(19) United States
(12) Patent Application Publication
(10) Pub. No.: US 2015/0227942 A1
(43) Pub. Date: Aug. 13, 2015

(54) SYSTEMS AND METHODS FOR ELECTRONICALLY DETERMINING ELIGIBILITY OF CERTIFIED PRE-OWNED STATUS FOR VEHICLES

(71) Applicant: Experian Information Solutions, Inc., (US)

(72) Inventors: John Sidman, Bolingbrook, IL (US); Joshua Steffan, Chicago, IL (US)

(73) Assignee: Experian Information Solutions, Inc., Costa Mesa, CA (US)

(21) Appl. No.: 13/734,855

(22) Filed: Jan. 4, 2013

Related U.S. Application Data
(60) Provisional application No. 61/583,540, filed on Jan. 5, 2012.

(51) Int. Cl. G06Q 30/00

(52) U.S. Cl. CPC G06Q 30/018

(57) ABSTRACT

Systems and methods are disclosed for electronically determining whether a vehicle is likely to satisfy the requirements of a certified-pre-owned (CPO) vehicle according to a certification program.

### CROSS-REFERENCE TO RELATED APPLICATIONS

This application claims the benefit of U.S. Provisional Application No. 61/583,540, filed on Jan. 5, 2012, the disclosure of which is hereby incorporated by reference in its entirety.

### BACKGROUND

This disclosure generally relates to methods and systems for electronically determining whether a vehicle is likely to satisfy the requirements of a certified-pre-owned (CPO) vehicle according to a CPO program.

Purchasing a used vehicle can often be a long and tedious process. There are few standards available to determine the quality of used vehicles or whether a vehicle's price is reasonable. One indicator that can be looked to is the certified-pre-owned (CPO) status of the vehicle, which is determined by individual manufacturers or certification entities based on a vehicle's history. Prior to a vehicle being CPO certified by a manufacturer or other certification entity, vehicle purchasers have few resources to assess the quality or reasonable price range for a vehicle.

### SUMMARY

There is a need for a system and method to help provide a potential buyer with a quick determination of whether a used vehicle will be eligible for CPO status. CPO eligibility can inform an individual or entity of whether a used vehicle is likely to have been inspected, refurbished, or certified by a manufacturer or other certification authority. Therefore, an individual or entity may wish to proactively determine whether a vehicle is likely to be eligible for CPO status. This can then influence the individual or entity's vehicle purchasing decision. Alternatively, a car dealer can use CPO eligibility to predict its sales and provide more accurate pricing on its vehicles.

The present disclosure provides a system and method for electronically determining eligibility of a vehicle's CPO status according to a CPO program. The user of this system and method may be an individual looking to sell a vehicle, a car dealer, or any other individual or entity interested in determining whether a used vehicle may be eligible to qualify as a CPO vehicle according to the CPO program. The CPO eligibility evaluation can provide valuable information to individuals to assist with their vehicle purchasing decision. A pre-purchase determination of a vehicle's CPO eligibility can help a car dealer determine how much to pay for a vehicle and in turn, how much to charge a customer for that vehicle. CPO eligibility can also be useful for entities, such as car dealers or manufacturers to predict or assess certain aspects of its business. For example, a car dealer may use this information and compare it to total number of car sales within its dealership. This comparison gives the car dealer insight to whether CPO eligible vehicles are more likely to be sold. Alternatively, this information can be compared with actual CPO certification. If the percentage of actual CPO certified vehicles is high when compared with CPO eligible vehicles, the car dealer would be incentivized to continue assessing whether a vehicle is eligible for CPO status. The eligibility information can also be used by manufacturers to determine which dealers are selling CPO approved vehicles.

In one embodiment, a system for electronically determining whether a vehicle is eligible to be considered a certified-pre-owned (CPO) vehicle according to a CPO program is disclosed. The system includes: a data store that stores a plurality of records comprising vehicle history data associated with vehicles; and a computing device in communication with the data store, the computing device operative to: receive a subject vehicle's identification information; determine a manufacturer of the subject vehicle; receive, from the first data store, vehicle history data regarding the subject vehicle; receive information associated with a CPO program related to the vehicle; and evaluate whether the subject vehicle is eligible to be considered a CPO vehicle according to the information associated with the CPO program and based on the vehicle history data regarding the subject vehicle.

Another aspect of the present disclosure provides a method for electronically determining whether a vehicle is eligible to be considered a certified-pre-owned (CPO) vehicle according to a CPO program. The method includes: storing, in a non-transitory storage medium, a plurality of records comprising vehicle history data associated with vehicles; communicating with a data store; receiving a subject vehicle's identification information; determining a manufacturer of the subject vehicle; receiving, from the first data store, vehicle history data regarding the subject vehicle; receiving information associated with a CPO program related to the subject vehicle; and evaluating whether the subject vehicle is eligible to be considered a CPO vehicle according to the information associated with the CPO program and based on the vehicle history data regarding the subject vehicle.

### BRIEF DESCRIPTION OF THE DRAWINGS

FIG. 1 is a block diagram illustrating one embodiment of a CPO qualification system in communication with a user device and data sources.

FIG. 2 is a block diagram depicting one embodiment of a CPO qualification system in communication with a network and various systems which are also in communication with the network.

FIG. 3 is a flowchart illustrating one embodiment of a method for determining eligibility of a vehicle's CPO status according to a CPO program.

### DETAILED DESCRIPTION

The terminology used in the description presented herein is not intended to be interpreted in any limited or restrictive manner, simply because it is being utilized in conjunction with a detailed description of certain specific embodiments of the development. Furthermore, embodiments of the development may include several novel features, no single one of which is solely responsible for its desirable attributes or which is essential to practicing the development described herein.

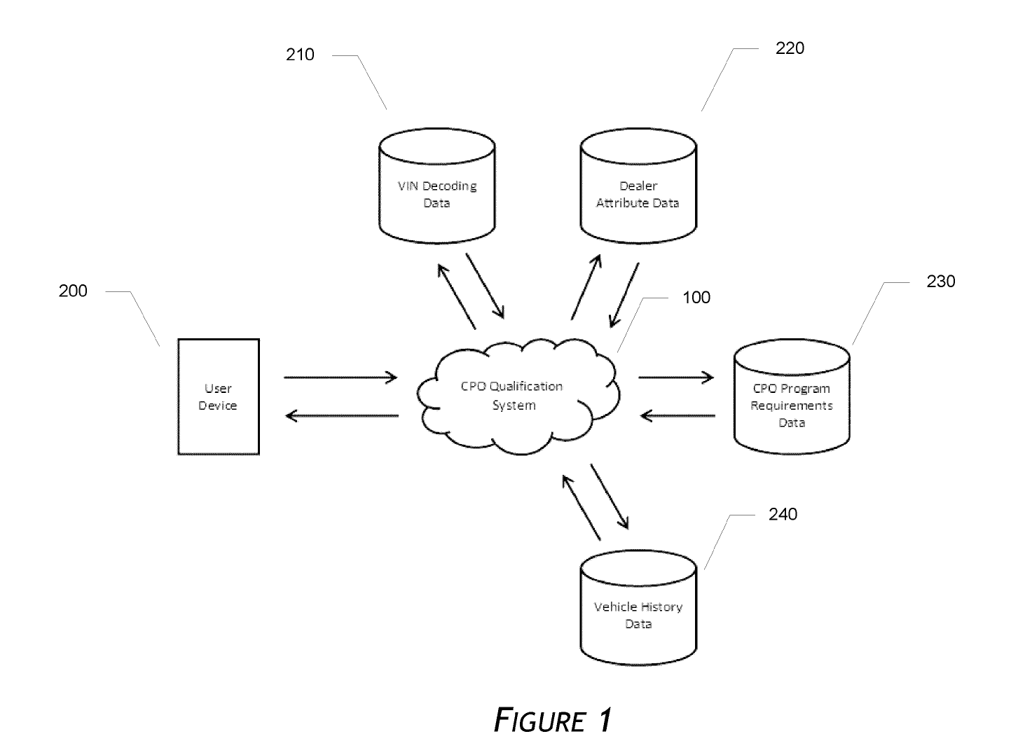

FIG. 1 is a system diagram of an embodiment of a certified-pre-owned (CPO) qualification system. The CPO qualification system 100 may be used to electronically determine, substantially in real-time, whether a particular vehicle, according to information regarding the vehicle's history, is eligible for CPO program designation. The CPO qualification system 100 selects from a CPO program requirements database 230 criteria associated with a manufacturer or certification entity's CPO program eligibility. The criteria for CPO eligibility may vary by manufacturer or certification entity. A vehicle's failure to satisfy any one criterion of a CPO program's requirements may not automatically disqualify the vehicle from CPO eligibility.

The CPO qualification system 100 may receive information from a user device 200, such as for example a mobile device application on a mobile device used by the user. The user may be a dealer, or any other individual or entity interested in determining whether a used vehicle may be eligible to qualify as a CPO vehicle according to a CPO program. In some embodiments, the user may be a wholesale auctioneer wishing to verify the CPO eligibility of all vehicles in a fleet. In this embodiment, the CPO qualification system 100 may receive multiple inputs of vehicle identification information from a user device 200 and CPO eligibility may be determined in bulk. In some embodiments, the user may be a manufacturer wishing to determine the compliance level of a plurality of dealers in promoting vehicles as CPO eligible when vehicles are determined to be as such. The vehicle identification information received by the mobile device application can include one or several vehicle identification number(s) (VIN(s)). The VIN(s) may be manually entered by the user, or scanned into the mobile device by the user. In some embodiments, the mobile device application may additionally require the user to enter login information. The mobile device application may then send the user's login information, as well as the VIN(s) to the CPO qualification system 100. In some embodiments, the user login information can also be used to retrieve any previously stored information or eligibility determinations by the CPO qualification system 100. This information can be stored in the user's account for a predetermined or manually selected period of time for future viewing.

In one embodiment, the CPO qualification system 100 may use the VIN(s) received from the user device 200 to determine the subject vehicle's make. In some embodiments, this determination may be performed by using information in a VIN decoding database 210. The VIN decoding database 300 may decode the VIN(s) received from the user device 200 and provide vehicle history information associated with the specific VIN(s). In some embodiments, the vehicle history information associated with the specific VIN(s) may be stored in and retrieved from the VIN decoding database 300. If the user is a dealer, the CPO qualification system 100 may also use the login information received to query a dealer attribute database 220 to determine if the dealer login information is consistent with the vehicle make associated with the vehicle(s). If the vehicle make and the dealer franchise are consistent, the CPO qualification system 100 may query a CPO program requirements database 230 to obtain requirements for that vehicle make's CPO program. The CPO program requirements may include assessing one or more of: a vehicle's warranty information, a vehicle's title, or a vehicle's accident history.

In some embodiments, the CPO qualification system 100 may also use the VIN received to query a vehicle history database 240. The CPO qualification system 100 may then compare the vehicle history results for the particular vehicle with the CPO program requirements for the make in order to determine the status of the vehicle's CPO eligibility. The vehicle history results that are verified may include verification of, for example, the vehicle's age, mileage, branding, accident history, ownership type, number of owners, and similar characteristics. The CPO eligibility requirements include at least some of these vehicle history elements. Using information from the vehicle history and the respective manufacturer or certification entity's eligibility criteria, the vehicle's eligibility is ascertained. Once the status is determined, the CPO qualification system 100 may return a report to the user device 200. The report may include the status of CPO eligibility for the vehicle, as well as some details of the vehicle's history. The CPO eligibility for the vehicle may be shown graphically by a check mark or by another indicator. In some embodiments, the CPO eligibility for multiple vehicles can be displayed in a list, with eligible and ineligible vehicles receiving a different indicator, for example, a check mark for eligible vehicles and an X for ineligible vehicles.

In one embodiment, the resulting list of CPO eligible vehicles can be used by entities, such as car dealerships, to predict or assess certain aspects of its business. For example, a car dealer can compare the number of CPO eligible vehicles with actual vehicles sold. This would give the dealer information on whether CPO eligibility improves its sales. A car dealer can also utilize the list of CPO eligible vehicles and cross check to see if the vehicles marked as CPO eligible actually are CPO approved. This can incentivize the car dealer to continue utilizing the CPO qualification system to promote its sales or adjust its inventory. The CPO eligibility information may also be used by manufacturers wishing to determine the compliance level of dealers in promoting CPO eligible vehicles.

### Computing System

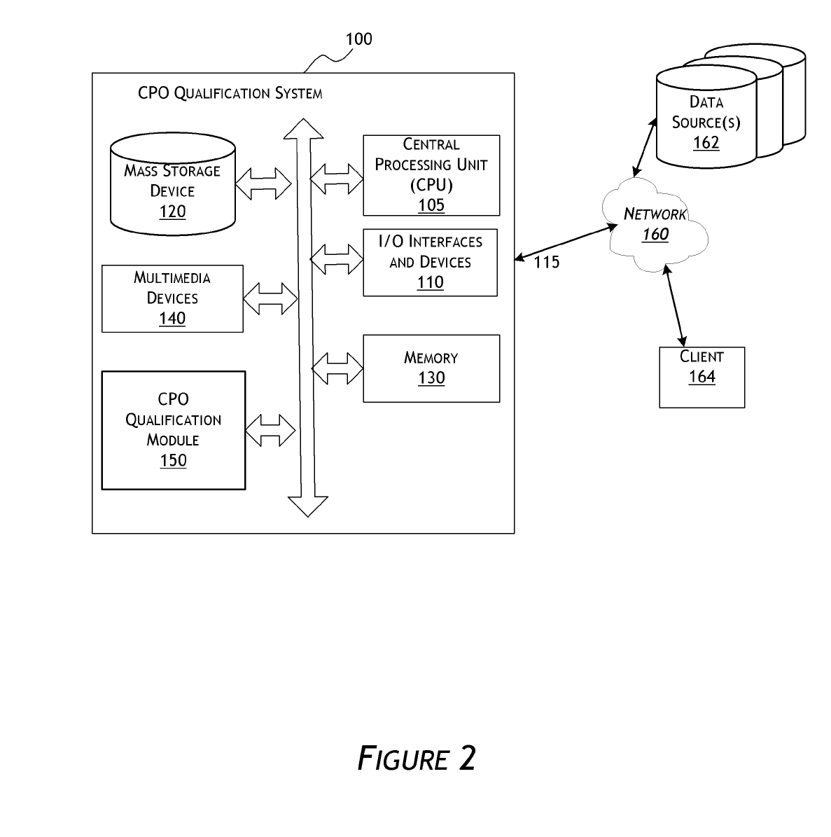

In some embodiments, the systems, computer clients and/or servers described above take the form of a computing system as shown in FIG. 2. FIG. 2 is a block diagram showing an embodiment in which CPO qualification system 100 is in communication with a network 160 and various systems are also in communication with the network 160. The CPO qualification system 100 may be used to implement systems and methods described herein. For example, the CPO qualification system 100 may be configured to receive a vehicle's VIN and determine the vehicle's eligibility for a CPO program. In some embodiments, the system is accessed remotely by the client 164, the system is local to the client 164, and/or a combination of the two. In addition to supplying data, client 164 may further request information from the CPO qualification system 100.

Although the description provided herein refers to individuals, consumers, or customers, the terms “individual,” “consumer,” and “customer” should be interpreted to include applicants, or groups of individuals or customers or applicants, such as, for example, married couples or domestic partners, organizations, groups, and business entities.

The CPO qualification system 100 includes, for example, a personal computer that is IBM, Macintosh, or Linux/Unix compatible. In one embodiment, the CPO qualification system 100 comprises a server, a laptop computer, a cell phone, a personal digital assistant, a kiosk, or an audio player, for example. In one embodiment, the exemplary CPO qualification system 100 includes a central processing unit (“CPU”) 105, which may include a conventional microprocessor. The CPO qualification system 100 further includes a memory 130, such as random access memory (“RAM”) for temporary storage of information and a read only memory (“ROM”) for permanent storage of information, and a mass storage device 120, such as a hard drive, diskette, or optical media storage device. Typically, the modules of the CPO qualification system 100 are connected to a computer (not shown) using a standard based bus system. In different embodiments, the standard based bus system could be Peripheral Component Interconnect (“PCI”), Microchannel, Small Computer System Interface (“SCSI”), Industrial Standard Architecture (“ISA”) and Extended ISA (“EISA”) architectures, for example. In addition, the functionality provided for in the components and modules of CPO qualification system 100 may be combined into fewer components and modules or further separated into additional components and modules.

The CPO qualification system 100 is generally controlled and coordinated by operating system software, such as Windows 95, Windows 98, Windows NT, Windows 2000, Windows XP, Windows Vista, Unix, Linux, SunOS, Solaris, or other compatible operating systems. In Macintosh systems, the operating system may be any available operating system, such as MAC OS X. In other embodiments, the CPO qualification system 100 may be controlled by a proprietary operating system. Conventional operating systems control and schedule computer processes for execution, perform memory management, provide file system, networking, I/O services, and provide a user interface, such as a graphical user interface (“GUI”), among other things.

The exemplary CPO qualification system 100 includes one or more commonly available input/output (I/O) devices and interfaces 110, such as a keyboard, mouse, touchpad, and printer. In one embodiment, the I/O devices and interfaces 110 include one or more display device, such as a monitor, that allows the visual presentation of data to a user. More particularly, a display device provides for the presentation of GUIs, application software data, and multimedia presentations, for example. The CPO qualification system 100 may also include one or more multimedia devices 140, such as speakers, video cards, graphics accelerators, and microphones, for example.

In the embodiment of FIG. 2, the I/O devices and interfaces 110 provide a communication interface to various external devices. In the embodiment of FIG. 2, the CPO qualification system 100 is electronically coupled to a network 160, which comprises one or more of a LAN, WAN, or the Internet, for example, via a wired, wireless, or combination of wired and wireless, communication link 115. The network 160 communicates with various computing devices and/or other electronic devices via wired or wireless communication links.

According to FIG. 2, information is provided to the CPO qualification system 100 over the network 160 from one or more data sources 162. The data sources 162 may include one or more of VIN decoding data 300, dealer attribute data 400, CPO program requirements data 500 and vehicle history data 600. In addition to the devices that are illustrated in FIG. 2, the network 160 may communicate with other data sources or other computing devices. In addition, the data sources 162 may include one or more internal and/or external data sources. In some embodiments, one or more of the databases or data sources may be implemented using a relational database, such as Sybase, Oracle, CodeBase and Microsoft® SQL Server as well as other types of databases such as, for example, a flat file database, an entity-relationship database, and object-oriented database, and/or a record-based database.

In the embodiment of FIG. 2, the CPO qualification system 100 also includes a CPO qualification module 150, which may be executed by the CPU 105. This module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In the embodiment shown in FIG. 2, the CPO qualification system 100 is configured to execute the CPO qualification module 150, among others, in order to electronically determine eligibility of CPO status for vehicles. In some embodiments, the CPO qualification module 150 may be configured to obtain data from the data source(s) 162.

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

It is recognized that the term “remote” may include data, objects, devices, components, and/or modules not stored locally, that is not accessible via the local bus. Thus, remote data may include a device which is physically stored in the same room and connected to the computing system via a network. In other situations, a remote device may also be located in a separate geographic area, such as, for example, in a different location, country, and so forth.

### Example Methods

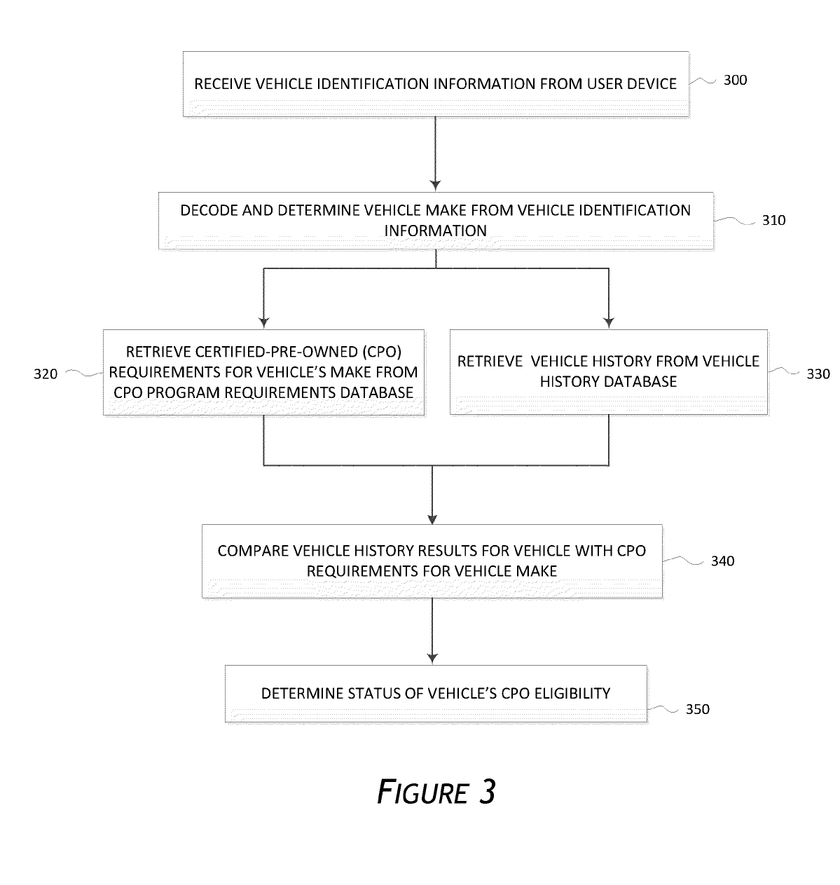

FIG. 3 is a flowchart illustrating one embodiment of a method for determining a vehicle's CPO eligibility status according to a CPO program. In an embodiment, the method shown in FIG. 3 may be performed substantially in real time so that the requesting individual or entity is presented with a vehicle's CPO eligibility status and/or detailed reports containing information related to a vehicle's CPO eligibility status without substantial delay. Alternatively, the method of FIG. 3 may be performed as a scheduled batch process for entities, such as CPO eligibility process that may be performed on a requesting entity's new vehicle inventory on a periodic basis. Depending on the embodiment, the method may be performed with fewer or additional blocks than are illustrated in FIG. 3. In one embodiment, the method of FIG. 3 is performed by the CPO qualification system 100. However, the method may be performed by one or more other suitable computing systems, such as a computing system that includes data scanning and CPO qualification modules that perform similar features to those discussed with reference to the CPO qualification system 100. For ease of discussion, the methods discussed below will be described with reference to the CPO qualification system 100. However, the methods may be performed by any other suitable computing system.

At block 300, the CPO qualification system 100 receives vehicle identification information obtained from a user device 200. In some embodiments, the vehicle identification information may be a VIN. The VIN may be manually entered by the user, or scanned into a user interface, such as through a web site or mobile device user interface. The vehicle identification information may be received by the CPO qualification system 100 individually or in bulk. In one embodiment, prior to entering in vehicle identification information, the requesting individual or entity may be prompted to create or enter user login information. This information may then be associated with the user's prior or future CPO eligibility inquiries. In some embodiments, this information can be stored in the user's account for a predetermined or manually selected period of time for future use.

At block 310, the CPO qualification system 100 decodes the vehicle identification information and determines the vehicle make from the decoded vehicle identification information. In some embodiments, this determination may be made by using information stored in a VIN decode database 210.

At block 320, the CPO qualification system 320 retrieves CPO requirements for the vehicle's make from the CPO program requirements database 230. In some embodiments, the CPO program requirements may be unique to a particular entity such as a dealer, which may certify the vehicle. If the user is a car dealer, the CPO qualification system 100 may also use the login information received to query a dealer attribute database 220 to determine if the dealer login information is consistent with the vehicle make associated with the vehicle. In some embodiments, the dealer login information may contain details about the dealer. For example, the dealer login information may be associated with the dealer's inventory and/or the make of the vehicles it carries in its inventory.

At block 330, the CPO qualification system 100 retrieves the vehicle history from the vehicle history database 240. If the vehicle make and the dealer franchise are consistent, the CPO qualification system may also use the VIN received to query a vehicle history database 240. The vehicle history results that are retrieved may include, for example, the vehicle's age, mileage, branding, accident history, ownership type, number of owners, and similar characteristics. The CPO eligibility requirements include at least some of these vehicle history elements.

At block 340, the CPO qualification system 100 may determine CPO eligibility of the vehicle by comparing the vehicle history results for the particular vehicle with the CPO program requirements for an individual manufacturer or certification entity. The CPO program requirements for an individual manufacturer or certification entity may be accessed through the CPO program requirements database 230. In some embodiments, the CPO program requirements may include assessing one or more of: a vehicle's warranty information, a vehicle's title, or a vehicle's accident history. A vehicle's failure to satisfy any one criterion of a manufacturer or certification entity's CPO program requirements may not automatically disqualify the vehicle from CPO eligibility.

At block 350, the CPO qualification system 100 determines the status of the vehicles CPO eligibility based on the CPO program requirements for an individual manufacturer or certification entity. The eligibility information may be displayed in any available file format, such as a spreadsheet or markup language format. The CPO eligibility information for the vehicle may be shown graphically by a check mark or by another indicator. In some embodiments, the CPO eligibility for multiple vehicles can be displayed in a list, with eligible and ineligible vehicles receiving a different indicator, for example, a check mark for eligible vehicles and an X for ineligible vehicles.

In one embodiment, the resulting list of CPO eligible vehicles can be used by entities, such as car dealers, to predict or assess certain aspects of its business. For example, a car dealer can compare the number of CPO eligible vehicles with actual vehicles sold. This would give the dealer information on whether CPO eligibility improves its sales of used vehicles. A car dealer can also utilize the list of CPO eligible vehicles and cross check to see if the vehicles marked as CPO eligible actually are CPO approved.

In some embodiments, the CPO qualification system 100 generates CPO eligibility information that allows a requesting entity to determine the likelihood that a particular certification entity will conclude that a vehicle is CPO approved. For example, the requesting entity can compare the number of vehicles it predicted would be CPO approved by the certification entity with the number of those vehicles which were actually approved. This information can enable the requesting entity to improve its prediction accuracy with respect to that certification entity. Furthermore, analysis of the types of information used by the requesting entity in its vehicle certification predictions as compared to the actual certification of those vehicles could be used to determine the impact of specific information with respect to the certification of the vehicle by the certification entity. Thus, this CPO eligibility information can inform a requesting entity which manufacturers or other certification entities are more likely to provide CPO approval of vehicles, and which criteria may be more important to a particular certification entity. The requesting entity can then use this information to create appropriate business strategies.

Use of such information developed by the CPO qualification system 100 enables a requesting entity to do things such as better predict its sales figures. This information will be helpful to the requesting entity in more accurately pricing the vehicle when selling it to a purchaser such as a dealer, who would then be expected to evaluate it for certification.

### Additional Embodiments

All of the processes described above may be embodied in, and be fully automated via, software code modules executed by one or more general purpose computers. The code module may be stored in any type of computer-readable medium or other computer storage device. Some or all of the methods may alternatively be embodied in specialized computer hardware. As will be apparent, the features, and attributes of the specific embodiments disclosed above may be combined in different ways to form additional embodiments, all of which are fall within the scope of the present disclosure. Although this disclosure has been described in terms of certain preferred embodiments and applications, other embodiments and applications that are apparent to those of ordinary skill in the art, including embodiments which do not provide all of the features and advantages set forth herein, are also within the scope of this disclosure.

What is claimed is:

1. A system for electronically determining whether a vehicle is eligible to be considered a certified-pre-owned (CPO) vehicle according to a CPO program, the system comprising:
a data store that stores a plurality of records comprising vehicle history data associated with vehicles; and
a computing device in communication with the data store, the computing device operative to:
receive a subject vehicle's identification information;
determine a manufacturer of the subject vehicle;
receive, from the first data store, vehicle history data regarding the subject vehicle;
receive information associated with a CPO program related to the vehicle; and
evaluate whether the subject vehicle is eligible to be considered a CPO vehicle according to the information associated with the CPO program and based on the vehicle history data regarding the subject vehicle.

2. The system of claim 1, wherein the vehicle history data in the data store may be obtained from dealer databases or data sources.

3. The system of claim 1, wherein the vehicle identification information includes a vehicle identification number (VIN) associated with a subject vehicle.

4. The system of claim 1, wherein the vehicle identification information can be received individually or in bulk.

5. The system of claim 4, wherein results of the evaluation of vehicle eligibility are presented in a report comparing the number of identified CPO eligible vehicles to actual CPO certified vehicles.

6. The system of claim 4, wherein the results of evaluation of vehicle eligibility are presented in a report comparing the number of identified CPO eligible vehicles to all CPO certified vehicles sold by a requesting entity.

7. The system of claim 4, wherein the results of evaluation of vehicle eligibility are used in a process for determining the likelihood of car sales based on percentage of CPO eligible vehicles in its inventory.

8. The system of claim 4, wherein the results of evaluation of vehicle eligibility are used in a process for determining vehicle pricing to customers based on CPO eligibility of inventoried vehicles.

9. The system of claim 4, wherein the results of evaluation are used in a process for determining vehicle purchase prices.

10. The system of claim 4, wherein the results of evaluation of vehicle eligibility are used in a process for determining which entities are more likely to approve a subject vehicle as a CPO vehicle.

11. The system of claim 1, wherein the CPO program eligibility of the subject vehicle is determined by criteria established by a manufacturer.

12. The system of claim 1, wherein the CPO program eligibility criteria is selected from a database containing individual manufacturer's CPO program requirements.

13. The system of claim 12, wherein the individual manufacturer's CPO program eligibility criteria may include one or more of:
a vehicle's warranty information;
a vehicle's title; or
a vehicle's accident history.

14. The system of claim 1, wherein the CPO eligibility of the subject vehicle may be graphically displayed as a check mark or other indicator.

15. A method for electronically determining whether a vehicle is eligible to be considered a certified-pre-owned (CPO) vehicle according to a CPO program, the method comprising:
storing, in a non-transitory storage medium, a plurality of records comprising vehicle history data associated with vehicles;
communicating with a data store;
receiving a subject vehicle's identification information;
determining a manufacturer of the subject vehicle;
receiving, from the first data store, vehicle history data regarding the subject vehicle;
receiving information associated with a CPO program related to the subject vehicle; and
evaluating using a processor whether the subject vehicle is eligible to be considered a CPO vehicle according to the information associated with the CPO program and based on the vehicle history data regarding the subject vehicle.

16. The method of claim 15, wherein receiving information associated with the CPO program eligibility criteria comprises selecting from a database containing individual manufacturer's CPO program requirements.

17. A non-transitory computer readable medium having computer executable instructions that when executed, cause a computing system to:
store a plurality of records comprising vehicle history data associated with vehicles;
communicate with a data store;
receive a subject vehicle's identification information;
determine a manufacturer of the subject vehicle;
receive, from the data store, vehicle history data regarding the subject vehicle;
receive information associated with a certified pre-owned (CPO) program related to the subject vehicle; and
evaluate whether the subject vehicle is eligible to be considered a CPO vehicle according to the information associated with the CPO program and based on the vehicle history data regarding the subject vehicle.

18. A system for electronically determining whether a vehicle is eligible to be considered a certified-pre-owned (CPO) vehicle according to a CPO program, the system comprising:
means for storing, in a non-transitory storage medium, a plurality of records comprising vehicle history data associated with vehicles;
means for communicating with a data store;
means for receiving a subject vehicle's identification information;
means for determining a manufacturer of the subject vehicle;
means for receiving, from the first data store, vehicle history data regarding the subject vehicle;
means for receiving information associated with a CPO program related to the subject vehicle; and
means for evaluating whether the subject vehicle is eligible to be considered a CPO vehicle according to the information associated with the CPO program and based on the vehicle history data regarding the subject vehicle.
